(19) United States
(12) Patent Application Publication
(10) Pub. No.: US 2026/0108920 A1
(43) Pub. Date: Apr. 23, 2026

(54) Pressure Washer and Spray Attachment for a Pressure Washer

(71) Applicant: Andreas Stihl AG & Co. KG, Waiblingen (DE)

(72) Inventors: Lukas Zürcher, Ludwigsburg (DE); Christian Krauer, Weinstadt (DE); Han Cao, Stuttgart (DE); Johannes Lücke, Fellbach (DE); Christopher Tost, Auenwald (DE)

(73) Assignee: Andreas Stihl AG & Co. KG, Waiblingen (DE)

(21) Appl. No.: 19/363,491

(22) Filed: Oct. 20, 2025

(30) Foreign Application Priority Data
Oct. 21, 2024 (EP) 24207820.2

(51) Int. Cl. B08B 3/02; B05B 7/02; B05B 12/00

(52) U.S. Cl. CPC B08B 3/026; B05B 7/02; B05B 12/002

(57) ABSTRACT

A pressure washer includes a port for a liquid source, a high-pressure pump, and a main line conveying liquid from the port to a spray opening by the high-pressure pump. A main line valve is arranged in the main line and is switchable between a closed state, in which liquid flow is stopped, and a fully open state, in which liquid flows through the main line. An operating device includes a valve control element and a pressure control element. The valve control element switches the main line valve between the closed and fully open states, while the pressure control element, operable independently of the valve control element, specifies the pressure of the liquid in the main line between the high-pressure pump and the spray opening, particularly when the main line valve is fully open.

### CROSS-REFERENCE TO RELATED APPLICATION

This application claims the benefit of European Patent Application EP 24207820.2, filed on Oct. 21, 2024, the content of which is incorporated by reference in its entirety.

### TECHNICAL FIELD

The disclosure relates to a pressure washer and to a handheld spray unit for a pressure washer.

### BACKGROUND

A pressure washer with a handheld spray unit is known from WO 2016/102075 A1, in which a lever is provided on the spray unit to open and close a main line valve to let liquid pass through. Before starting up the pressure washer, one of three pressure increments can be selected by a panel arranged remote from the lever. As a result, the pressure in the main line of the pressure washer can be specified.

### SUMMARY

An aspect of the invention is to provide an improved pressure washer, and a handheld spray unit, to enable convenient and flexible operation of the pressure washer, and of the of handheld spray unit, in particular while the pressure washer is in operation. This object is solved by a pressure washer and by a handheld spray unit for a pressure washer as disclosed herein.

In both cases, the pressure washer comprises a port for a liquid source, a high-pressure pump, a main line, through which liquid can be conveyed from the port to a spray opening in the main line by the high-pressure pump, and a main line valve which is arranged in the main line. When the main line valve is in a closed state it stops liquid from flowing through the main line. When the main line valve is in a fully open state it lets liquid flow through the main line. In particular, the flow cross-section of the main line at the location of the main line valve is at maximum when the main line valve is in the fully open state.

The pressure washer comprises an operating device. The handheld spray unit comprises an operating device. The main line valve can be switched by the operating device between the fully open state and the closed state.

The operating device comprises a valve control element and a pressure control element. The valve control element is provided for switching the main line valve between the fully open state and the closed state. The pressure control element is provided for specifying, in particular for regulating, the pressure of the liquid in the main line in the section between the high-pressure pump and the spray opening. In particular, by the pressure control element, it is possible to specify, in particular to regulate, the pressure of the liquid in the main line in the section between the high-pressure pump and the spray opening when the main line valve is in the fully open state. The pressure control element can be operated independently of the valve control element. In particular, the pressure control element can be operated independently of the valve control element, at least when the non-actuated pressure control element is actuated in a first section of its travel path. In particular, the valve control element can be actuated without the pressure control element being simultaneously actuated. In particular, the pressure control element can be actuated without the valve control element being simultaneously actuated. In particular, the valve control element and the pressure control element are not coupled to each other, in particular they are not mechanically coupled to each other. However, such coupling may also be provided. In particular, it can be provided that the pressure control element can be pressed mechanically without the valve control element being simultaneously pressed in the process. In particular, the pressure washer, in particular the handheld spray unit, can be designed such that the pressure control element does not trigger any function when actuated without simultaneous actuation of the valve control element. In particular, there is no pressure change triggered by the pressure control element. In particular, this separation of mechanical actuation and functional release is effected by control technology. As a result, the pressure control element and the valve control element are subjected to minimal wear. Mechanical coupling of pressure control element and valve control element is not necessary. In particular, the pressure washer, in particular the handheld spray unit, comprises a control unit. In particular, on actuation of the pressure control element and/or of the valve control element, signals are sent to the control unit. In particular, the control unit only allows a change in the pressure following actuation of the pressure control element if the valve control element is also actuated at the same time. This can prevent an increase in the pressure on the closed main line valve. As a result, the main line valve is subjected to minimal wear.

Because the pressure washer, in particular the spray unit, comprises an operating device with a valve control element and a pressure control element, comfortable operation of the pressure washer, in particular of the spray unit, is possible. Both the pressure control element and the valve control element can be actuated ergonomically.

In particular, the handheld spray unit is a component part of the pressure washer. In particular, the spray opening is arranged on the handheld spray unit. In particular, the operating device is arranged on the handheld spray unit. As a result, comfortable actuation of the operating device is possible during operation of the pressure washer, in particular while guiding the handheld spray unit.

In particular, the handheld spray unit has a handle area. In particular, a user can guide the handheld spray unit when gripping the handle area. In particular, the valve control element and the pressure control element can be operated together with a single hand of the user when gripping the handle area. This makes it possible to operate the operating device comfortably and ergonomically. The use of a second hand is not absolutely necessary while liquid is being sprayed and during simultaneous pressure adjustment of the pressure in the main line. In particular, the valve control element and the pressure control element can be operated together with a single finger of the user when gripping the handle area. As a result, the operator can use a single finger to switch the main line valve and specify, in particular influence, in particular regulate, the pressure of the liquid in the main line in the section between the high-pressure pump and the spray opening. This is possible in particular while the liquid is being sprayed out of the spray opening. This makes comfortable and flexible operation of the spray unit, in particular of the pressure washer possible. The operator can ergonomically specify operating commands with a single finger while guiding the handheld spray unit.

In particular, the pressure control element can be operated with a single three-joint finger when gripping the handle area. For example, the pressure control element can be operated when gripping the handle area with the index finger. In particular, during operation of the pressure control element with the single three-joint finger, the valve control element can be operated with another three-joint finger of the same hand. For example, while the pressure control element is being operated with the index finger, the valve control element can be operated with the middle finger of the same hand. This enables particularly ergonomic operation of the handheld spray unit, in particular the pressure washer. The thumb is a two-joint finger rather than a three-joint finger.

In a particular development, it is provided that the valve control element is a pivot lever that is pivotable about a valve control element pivot axis. In particular, the pressure control element is a pivot lever that is pivotable about a pressure control element pivot axis. In particular, the valve control element has a valve point arranged at a maximum valve distance from the valve control element pivot axis and is accessible in particular for the operator from the outside, in particular can be actuated by them. The valve point has in particular the maximum valve distance from the valve control element pivot axis in the sense that it is the point of the valve control element which, in the non-actuated state of the valve control element, is accessible to the operator for the purpose of actuating the valve control element, in particular in that it can be actuated with a finger by placing the finger directly on the valve point, and simultaneously has the greatest distance from the valve control element pivot axis. In particular, the pressure control element has a pressure point arranged at a maximum pressure distance from the pressure control element pivot axis and is accessible in particular for the operator from the outside, in particular can be actuated by them. The pressure point has in particular the maximum pressure distance from the pressure control element pivot axis in the sense that it is the point of the pressure control element which, in the non-actuated state of the pressure control element, is accessible to the operator for the purpose of actuating the pressure control element, in particular in that it can be actuated with a finger by placing the finger directly on the pressure point, and simultaneously has the greatest distance from the pressure control element pivot axis. In particular, the maximum valve distance is greater than the maximum pressure distance. Owing to the greater leverage that can be exerted when operating the valve control element, the valve control element can be operated with minimal force exertion. A large torque can be generated with little force. This enables the main line valve to be opened comfortably and as easily as possible by the valve control element. Owing to the small maximum pressure distance, the pressure control element can have a small and compact design. This enables ergonomic operation of the operating device. In addition, the differently sized maximum distances for the maximum valve distance and the maximum pressure distance enable the operating device to be designed such that both the pressure control element and the valve control element can be actuated individually, in each case without the other control element being actuated. In particular, the maximum valve distance is at least 150%, in particular 200% of the maximum pressure distance. Owing to the small maximum pressure distance, the pressure control element designed as a pivot lever has a small pivot circle. As a result, the pressure control element can be operated ergonomically.

In a particular development, the valve control element has a recess. The pressure control element is received at least partially in the recess. In particular, the pressure control element protrudes through the recess of the valve control element. As a result, the operating device, which comprises the valve control element and the pressure control element, can have a compact overall design. Joint operation of both valve control element and pressure control element is possible in this way. In particular, the pressure control element can be actuated during actuation of the valve control element simultaneously with the same hand, in particular with the same finger, in particular with the same three-joint finger. In particular, it is possible to operate the pressure control element with a three-joint finger and the valve control element with a directly adjacent three-joint finger on the same hand, in particular simultaneously.

In particular, the pressure control element is pivotably mounted on the valve control element. The pressure control element pivot axis runs in particular through the valve control element. This design of the operating device consisting of the pressure control element and the valve control element makes the operating device very ergonomic. In particular, the pressure control element pivot axis is arranged at a distance from the valve control element pivot axis. As a result, even in the case of a large pivot circle for the valve control element, a small pivot circle can be realised for the pressure control element. In this case it is possible to arrange the two pivot axes such that ergonomic operation is possible in particular of the pressure control element.

In particular, the pressure washer has a motor for driving the high-pressure pump. The motor has an off state and an on state. The motor can be adjusted between the off state and the on state by the valve control element. Due to this further functionality assigned to the valve control element, particularly comfortable operation of the pressure washer, in particular of the handheld spray unit is possible. In particular, it can be provided that the motor is transferred to the off state when the valve control element is transferred to a non-actuated state. Therefore, if the main line valve is closed, the motor is switched off shortly before or at the same time or shortly thereafter, which prevents the motor from generating unwanted pressure against the closed main line valve by the high-pressure pump.

In particular, the pressure washer, in particular the handheld spray unit, comprises a detector. The detector is designed to detect an adjustment position of the pressure control element. In particular, the detector has a potentiometer or a hall sensor. In particular, the detector is a potentiometer or a hall sensor. In particular, a mechanical connecting element is arranged between the detector and the pressure control element. Expediently, on the basis of a detector path covered by a position element of the detector, the detector determines the value of the pressure in the main line specified by the pressure control element. In particular, the position element can be adjusted along a maximum detector path. In particular, the pressure control element can be adjusted along a maximum travel path. In particular, the maximum travel path corresponds to at least 110%, in particular at least 150%, in particular at least 200%, of the maximum detector path. As a result, translation between the pressure control element and the position element of the detector is possible. Owing to the larger maximum travel path of the pressure control element compared to the maximum detector path of the position element, the pressure desired in the main line can be specified very precisely by the pressure control element.

In particular, the main line has a suction chamber between the port and the high-pressure pump. The main line has in particular a pressure chamber between the high-pressure pump and the spray opening. In a particular design, the pressure chamber is fluidically connected to the suction chamber via a bypass line. A bypass valve is arranged in particular in the bypass line. In particular, an open cross-sectional area of the bypass line can be set by the bypass valve in order to regulate the pressure in the pressure chamber. Expediently, the bypass valve can be adjusted by the pressure control element in order to set the open cross-sectional area of the bypass line. In particular, a cross-sectional area of the bypass line can be specified by the pressure control element. This enables comfortable operation of the pressure washer.

In particular, the pressure washer is designed such that the bypass valve sets the size of the open cross-sectional area depending on the adjustment position of the pressure control element. In particular, the size of the open cross-sectional area can be adjusted by the pressure control element in at least six increments, in particular in at least 10 increments, in particular in at most 30 increments, in particular in at most 20 increments. As a result, the pressure in the section between the high-pressure pump and the spray opening can be set very precisely, in particular adjusted quasi-continuously. In particular, the size of the open cross-sectional area can be adjusted by the pressure control element quasi-continuously. This makes it appear to the operator as if the pressure in the section of the main line between the high-pressure pump and the spray opening can be specified, in particular regulated, continuously. The pressure of the liquid in the main line between the high-pressure pump and the spray opening can be specified without increments by the pressure control element, in particular in the fully open state of the main line valve. As a result, comfortable operation of the pressure washer is possible. The pressure in the main line in the section between the high-pressure pump and the spray opening can be accurately adapted to the respective use conditions.

In a particular embodiment, the pressure washer is designed such that it is only possible to adjust the operating state of the motor between the off state and the on state if the valve is in the fully open state. This can prevent the motor and the high-pressure pump from exerting great pressure on the main line valve when pumping the liquid. Because the pressure washer is designed such that it is only possible to adjust the operating state of the motor if the main line valve is in the fully open state, the motor can only be switched from the on state to the off state if the main line valve is in the fully open state. This ensures that the pressure that is in the main line owing to the pumping of the liquid by the high-pressure pump can be at least partially reduced when the motor is transferred from the on state to the off state. This prevents the main line valve from being exposed to a large pressure after the transfer into the closed state. The components involved in switching the motor off and on are not exposed to any pressure, or only to a low pressure, by the liquid conveyed by the pump. Owing to the lower pressure in the main line, in particular if the valve is in the closed state and the motor is in the off state, minimal force is required to set the valve to the fully open state. The operator merely has to apply minimal force in this case, since they do not need to work against a high pressure of the liquid in the main line. This enables comfortable use of the pressure washer.

### BRIEF DESCRIPTION OF THE DRAWINGS

Exemplary embodiments of the invention are explained hereinafter with reference to the drawings.

FIG. 1 shows a perspective illustration of a pump unit of a pressure washer.

FIGS. 2 and 3 show perspective illustrations of a handheld spray unit of the pressure washer.

FIG. 4 shows a side view of the handheld spray unit according to FIGS. 2 and 3.

FIG. 5 shows a schematic illustration of a pressure washer with non-actuated pressure control element and non-actuated valve control element.

FIG. 6 shows a schematic illustration of the pressure washer from FIG. 5 with actuated valve control element and non-actuated pressure control element.

FIG. 7 shows a schematic illustration of the pressure washer from FIG. 5 with actuated valve control element and with actuated pressure control element.

FIG. 8 shows a schematic illustration of the handheld spray unit of the pressure washer from FIG. 5 with actuated valve control element and actuated pressure control element, where the hand of the user performing the actuation is shown schematically.

FIG. 9 shows a sectional illustration of a section through the handheld spray unit from the FIGS. 2 to 4 in the case of non-actuated pressure control element and non-actuated valve control element.

FIG. 10 shows a sectional illustration similar to FIG. 9 in the case of actuated valve control element and non-actuated pressure control element.

FIG. 11 shows a sectional illustration similar to the sectional illustration from FIG. 9 in the case of actuated valve control element and actuated pressure control element.

FIG. 12 shows an illustration of a detail from FIG. 9.

FIG. 13 shows an illustration of a detail from FIG. 11.

### DETAILED DESCRIPTION

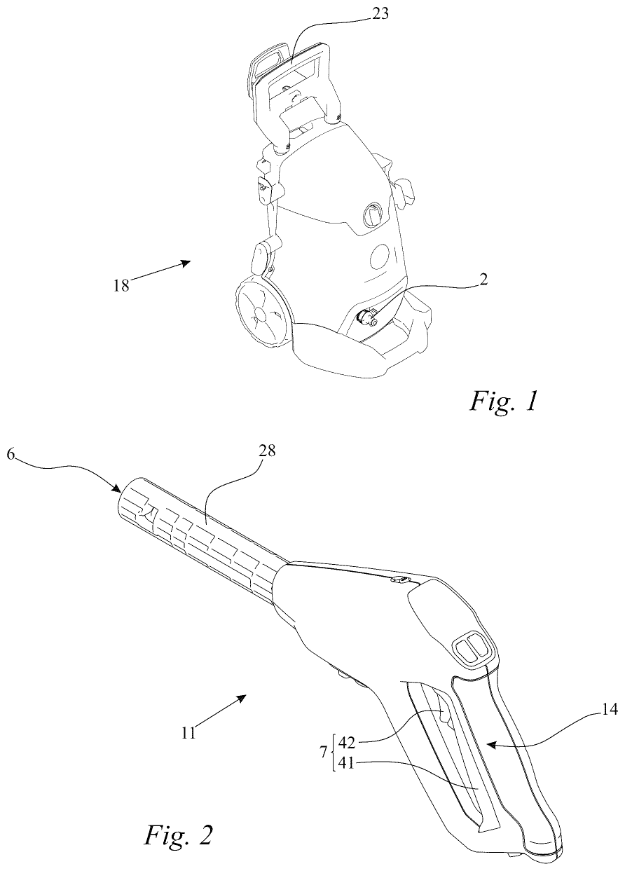

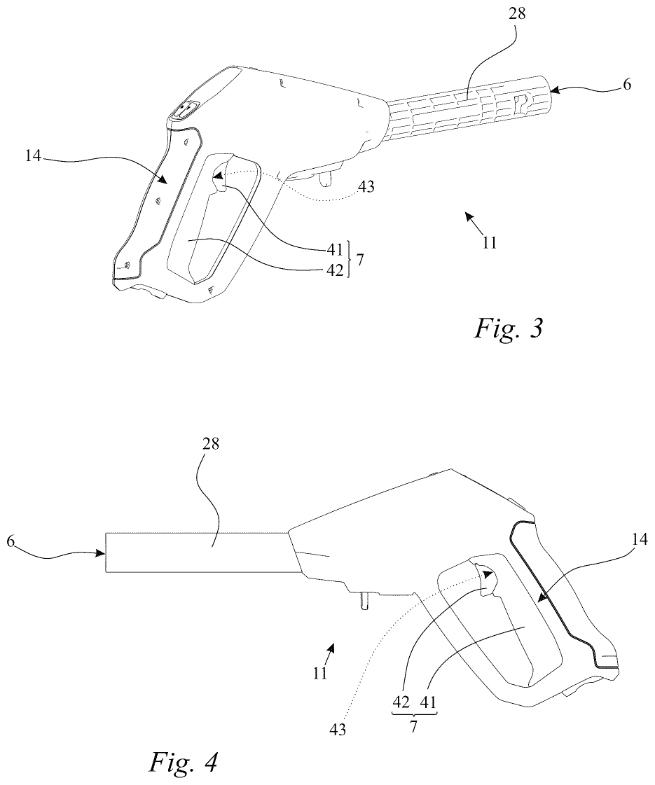

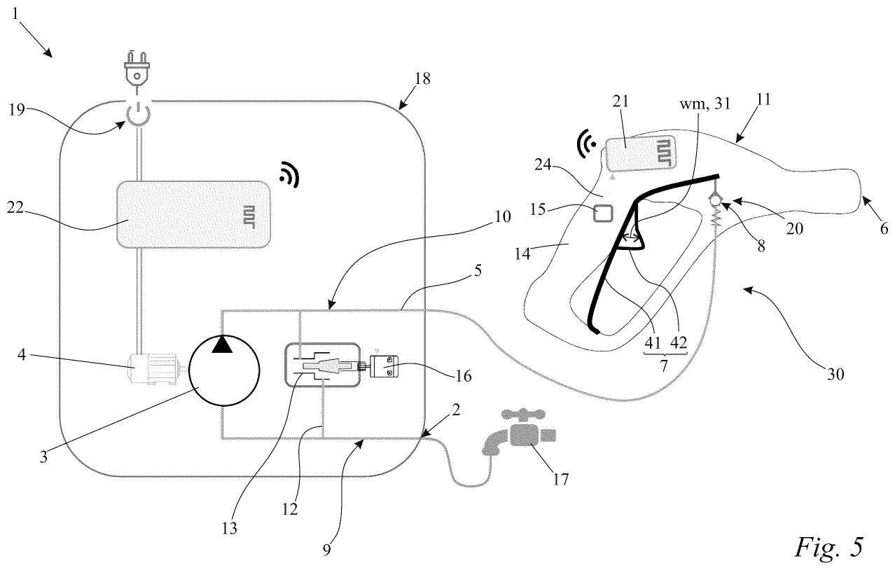

FIG. 1 shows a pump unit 18 of a pressure washer 1 shown schematically in FIG. 5. In a first exemplary embodiment, the pressure washer 1 comprises a spray unit 11 shown in FIG. 2. In a second exemplary embodiment, the pressure washer 1 comprises a spray unit 11 shown in FIG. 5. As shown in FIG. 5, the pump unit 18 and the spray unit 11 are fluidically connected to one another via a main line 5. The spray unit 11 in the second exemplary embodiment is a gun. This shown schematically in FIG. 5. However, it can also be provided that the spray unit 11 comprises a gun and a lance, as shown in FIGS. 2 to 4. The following description applies, unless expressly stated, to both exemplary embodiments - even if the corresponding features are only described in conjunction with one of the figures.

The pressure washer 1, in particular the spray unit 11, is designed to clean objects with pressurised cleaning liquid. In the exemplary embodiments, the pressure washer 1 portable. The pressure washer 1 has a handle 23 shown in FIG. 1. The pressure washer 1, in particular the pump unit 18 of the pressure washer 1, is portable by the handle 23. In normal operation, it is provided that the pressure washer 1, in particular the pump unit 18, is set down.

As shown in FIG. 5, the pressure washer 1 has a high-pressure pump 3. The high-pressure pump 3 is a component part of the pump unit 18. Cleaning liquid in the pressure washer 1, in particular in the pump unit 18, can be pressurised by the high-pressure pump 3. By the high-pressure pump 3, the cleaning liquid can be pressurised to a pressure of at least 10 bar, in particular of at least 15 bar, in particular of at least 30 bar, in particular of at least 100 bar. In particular, the cleaning liquid can be pressurised with the high-pressure pump 3 to a pressure of at most 600 bar, in particular of at most 500 bar. The high-pressure pump 3 comprises at least one piston (not shown). The at least one piston is able to move back and forth to generate pressure on the cleaning liquid. The high-pressure pump 3 typically comprises three pistons.

As shown in FIGS. 1 and 5, the pressure washer 1, in particular the pump unit 18, comprises a port 2 for a liquid source 17. In the exemplary embodiments, the liquid source 17 is an external liquid source. In the exemplary embodiments, the external liquid source is the water tap of a domestic water supply. It can also be provided that the liquid source is an integral component part of the pressure washer 1. The pressure washer 1, in particular the handheld spray unit 11, comprises a spray opening 6. The pressure washer 1 comprises the main line 5. The main line 5 of the pressure washer 1 fluidically connects the port 2 to the spray opening 6. The port 2 is arranged on the pump unit 18. The spray opening 6 is arranged on the spray unit 11. In the exemplary embodiment according to FIGS. 2 to 4, the spray opening 6 is arranged on a lance 28 of the spray unit 11. In the exemplary embodiment according to FIG. 5, the spray opening 6 is arranged on the spray unit 11 designed as a gun.

By the high-pressure pump 3, liquid can be conveyed through the main line 5 from the port 2 to the spray opening 6. The liquid source 17 supplies liquid to the main line 5 liquid. The high-pressure pump 3 is arranged in the main line 5. The high-pressure pump 3 pressurises the liquid. The high-pressure pump 3 is arranged between a suction chamber 9 and a pressure chamber 10 of the main line 5. This is shown in FIG. 5. The main line 5 has the suction chamber 9 between the port 2 and the high-pressure pump 3. The main line 5 has the pressure chamber 10 between the high-pressure pump 3 and the spray opening 6. In the exemplary embodiments, the suction chamber 9 is formed by a section of the main line 5 between the port 2 and the high-pressure pump 3. In the exemplary embodiments, the pressure chamber 10 is formed by a section of the main line 5 between the high-pressure pump 3 and the spray opening 6. This section of the main line 5 extends in particular right from the high-pressure pump 3 right up to the spray opening 6. The high-pressure pump 3 conveys liquid from the suction chamber 9 to the pressure chamber 10. A larger pressure prevails in the pressure chamber 10 than in the suction chamber 9. The suction chamber 9 and the pressure chamber 10 are component parts of the main line 5. A greater pressure prevails in the main line 5 downstream of the high-pressure pump 3 than upstream of the high-pressure pump 3.

The high-pressure pump 3 is arranged in the pump unit 18. The high-pressure pump 3 is separate from the spray unit 11. Different spray units 11 can be connected to the high-pressure pump 3. To drive the high-pressure pump 3, the pressure washer 1 has a motor 4. The motor 4 is arranged in the pump unit 18. The motor 4 can be a brushless DC motor. A brushless DC motor is also called an EC motor. The motor can also be a universal motor. In the exemplary embodiments, the motor 4 is an induction motor. In an induction motor, a revolving magnetic field of the stator sets the rotor in motion. The induction motor in the exemplary embodiments is operated with AC voltage. The voltage source can be provided, for example, by the mains voltage. If battery or rechargeable battery operation is provided, the motor may also be a brushless DC motor. It can then be provided that the rechargeable battery is a component part of the pressure washer 1. In particular, it can then be provided that the pump unit 18 is a component part of the handheld spray unit 11 is. In this case, the entire pressure washer 1 is portable during operation and can be controlled with the hand.

As shown in FIG. 5, the pressure washer 1 comprises a main switch 19. The main switch 19 serves to interrupt the voltage supply to the entire pressure washer 1. The main switch 19 is arranged on the pump unit 18.

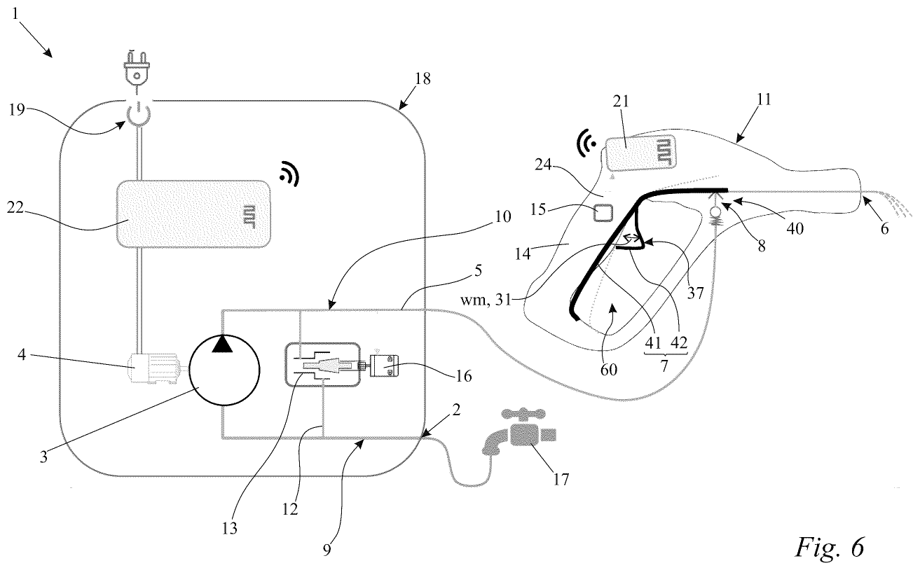

The pressure washer 1 comprises a main line valve 8. The main line valve 8 is arranged in the main line 5. In the exemplary embodiments, the main line valve 8 is arranged in the spray unit 11. The main line valve 8 has two valve states. The two valve states comprise a closed state 20 (FIG. 5) and a fully open state 40 (FIG. 6). When the main line valve 8 is in the fully open state 40, it lets liquid flow through the main line 5. In the fully open state 40, the flow cross-section of the main line 5 located at the position of the main line valve 8 at a maximum. Opening the main line valve 8 further does not lead in the fully open state 40 to a larger flow cross-section for the liquid in the main line 5 at the position of the main line valve 8. When the main line valve 8 is in the closed state 20 it stops liquid from flowing through the main line 5, in particular completely. When the main line valve 8 is in the fully open state 40 during operation of the pressure washer 1, liquid is sprayed out of the spray opening 6. In the closed state 20 of the main line valve 8, no liquid is sprayed out of the spray opening 6. In the exemplary embodiments, the main line valve 8 is arranged between the high-pressure pump 3 and the spray opening 6. However, it can also be provided that the main line valve 8 is arranged in the pump unit 18. It can also be provided that the main line valve 8 is arranged between the port 17 and the high-pressure pump 3.

The pressure washer 1, in particular the spray unit 11, has an operating device 7. The operating device 7 is designed to be separate from the main switch 19. The main line valve 8 can be switched by the operating device 7 between the fully open state 20 and the closed state 40. In the exemplary embodiments, the operating device 7 is arranged on the spray unit 11.

The operating device 7 has a valve control element 41 and a pressure control element 42. The pressure control element 42 can be operated independently of the valve control element 41. The pressure washer 1, in particular the spray unit 11, is designed such that the valve control element 41 can be actuated without actuation of the pressure control element 42. The pressure washer 1, in particular the spray unit 11, may be designed such that the pressure control element 42 can be actuated without the valve control element 41 being actuated at the same time. However, such a coupling can also be provided. In particular, it can be provided that the pressure control element 42 can be pressed mechanically, without the valve control element 41 being simultaneously pressed in the process. In the exemplary embodiments, the pressure washer 1 is designed such that the pressure control element 42 does not trigger any function when actuated without simultaneous actuation of the valve control element 41. In this case, no change in the pressure in the main line 5 that is triggered by the pressure control element 42 takes place. This separation of mechanical actuation and functional release is effected by control technology.

The main line valve 8 can be switched by the valve control element 41 between the fully open state 40 and the closed state 20. The pressure of the liquid in the main line 5 in the section between the high-pressure pump 3 and the spray opening 6 can be specified by the pressure control element 42. The pressure of the liquid in the pressure chamber 10 can be specified by the pressure control element 42. In particular, the pressure of the liquid in the main line 5 in the section between the high-pressure pump 3 and the spray opening 6 can be specified by the pressure control element 42 in the fully open state 40 of the main line valve 8. The pressure of the liquid in the main line 5 may be set in the section between the high-pressure pump 3 and the spray opening 6 by the pressure control element 42.

As shown in FIG. 5, the pressure washer 1, in particular the pump unit 18, has a bypass line 12. The pressure chamber 10 is fluidically connected to the suction chamber 9 by the bypass line 12. Due to the bypass line 12, a further fluidic connection of suction chamber 9 and pressure chamber 10 is possible separately from the fluidic connection of the suction chamber 9 to the pressure chamber 10 via the high-pressure pump 3.

If the high-pressure pump 3 is in operation, a greater pressure prevails in the pressure chamber 10 than in the suction chamber 9. Owing to this pressure gradient, liquid can flow from the pressure chamber 10 into the suction chamber 9 through the bypass line 12. A bypass valve 13 is arranged in the bypass line 12. By the bypass valve 13, an open cross-sectional area of the bypass line 12 can be set. As a result, the pressure in the pressure chamber 10 can be regulated. In the case of a larger open cross-sectional area, pressure equalisation between the pressure chamber 10 and the suction chamber 9 takes place to a greater extent. If a high pressure is intended to prevail in the pressure chamber 10, the open cross-sectional area of the bypass line 12 is reduced by the bypass valve 13. The larger the open cross-sectional area of the bypass line 12, in particular of the bypass valve 13, the greater the volumetric flow rate through the bypass line 13, in particular through the bypass valve 13, during operation, given otherwise unchanged conditions.

The bypass valve 13 can be adjusted between a fully closed state and a fully open state in increments or without increments. The bypass valve 13 can have different degrees of closure between the fully closed state and the fully open state. In the exemplary embodiments, the bypass valve 13 can be adjusted continuously at least in sections. It can also be provided that the bypass valve can be adjusted between the fully closed state and the fully open state continuously without interruption. The pressure washer 1 is designed such that the bypass valve 13 sets the size of the open cross-sectional area as a function of the adjustment position of the pressure control element 42. In particular, the size of the open cross-sectional area can be adjusted by the pressure control element 42 in at least six, in particular in at least ten increments. It can also be provided that size of the open cross-sectional area can be adjusted continuously by the pressure control element. In the exemplary embodiments, the size of the open cross-sectional area can be adjusted by the pressure control element 42 in particular in at most 30, in particular in at most 20 increments. In the exemplary embodiments, the size of the open cross-sectional area can be adjusted quasi-continuously by the pressure control element 42. Quasi-continuously is understood here to mean that the different pressure increments are so close together that it appears to the user as if the pressure adjusts continuously when they actuate the pressure control element 42.

The magnitude of the volumetric flow rate of the liquid in the main line can be set as a function of the degree of closure of the bypass valve 13. The more the bypass valve 13 is closed, the smaller the open cross-sectional area of the bypass line 12. The more the bypass valve 13 is closed, the greater the volumetric flow rate of the liquid in the main line 5, in particular in the section between high-pressure pump 3 and spray opening 6. The more the bypass valve 13 is closed, the greater the volumetric flow rate of the liquid in the main line 5 at the spray opening 6.

The bypass valve 13 can be adjusted by the operating device 7, in particular by the pressure control element 42. In the exemplary embodiments, the pressure control element 42 serves to set the open cross-sectional area of the bypass line 12. By adjusting the bypass valve 13, the pressure in the main line 5, in particular in the pressure chamber 10, in particular at the spray opening 6 can be regulated. It can also be provided that the pressure in the pressure chamber is regulated in some other way. For example, instead of using the bypass line and the bypass valve for this, the motor speed of the motor 4 can be varied. In this case, the pressure control element 42 is used to specify, in particular to set, a motor speed of the motor 4.

By the operating device 7, the main line valve 8 can be switched between the fully open state 20 and the closed state 40 and the pressure can be specified, in particular set, in the main line 5 in the section between the high-pressure pump 3 and the spray opening 6.

The spray unit 11 can move in relation to the pump unit 18. The main line 5 in the exemplary embodiments is designed as a flexible hose between the pump unit 18 and the spray unit 11. The spray opening 6 is arranged on the spray unit 11. The spray unit 11 can be directed with its spray opening 6 at an object intended to be cleaned. The spray unit 11 is handheld. The operating device 7 is arranged on the spray unit 11. A user can guide the spray unit 11 with one hand and simultaneously operate the operating device 7 with the same hand.

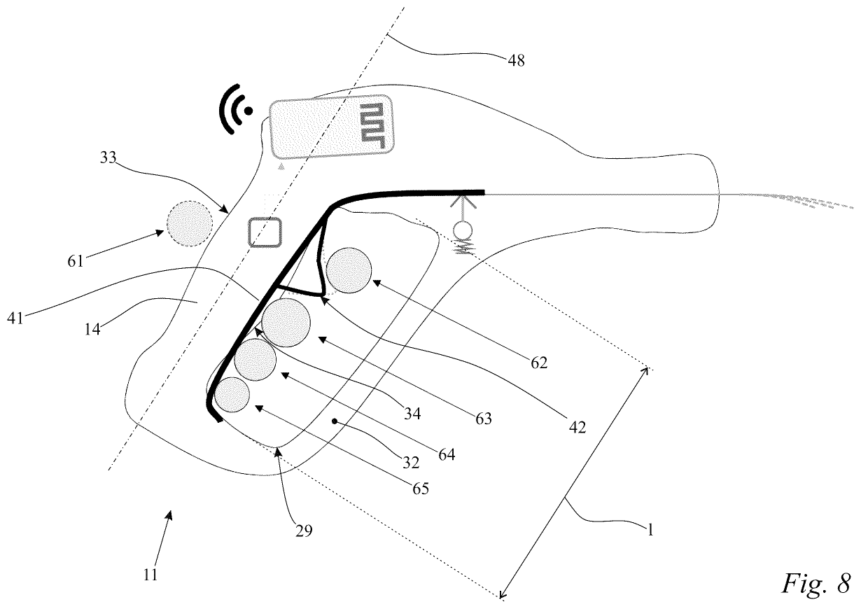

The handheld spray unit 11 has a handle area 14. The operating device 7 is arranged in the handle area 14. Both the valve control element 41 and the pressure control element 42 are arranged in the handle area 14. The pressure washer 1 is designed such that a user can hold the handheld spray unit 11 by gripping the handle area 14 with one hand and can simultaneously actuate the operating device 7, in particular both the valve control element 41 and the pressure control element 42, with the same hand. This shown in particular in FIG. 8. In particular, the pressure washer 1 is designed such that a user can hold the handheld spray unit 11 by gripping the handle area 14 with one hand and can simultaneously actuate the operating device 7, in particular both the valve control element 41 and the pressure control element 42, with solely three-joint fingers of the same hand. In particular, the pressure washer 1 is designed such that a user can hold the handheld spray unit 11 by gripping the handle area 14 with one hand and can simultaneously actuate the operating device 7, in particular both the valve control element 41 and the pressure control element 42, with a single finger, in particular with a single three-joint finger.

In the exemplary embodiments, the pressure washer is designed such that a user can hold the handheld spray unit 11 by gripping the handle area 14 with one hand and can simultaneously actuate the operating device 7 with solely a single three-joint finger of the same hand, in particular with the index finger.

During typical operation of the pressure washer 1, in particular of the spray unit 11, actuation of the operating device 7 with the thumb is not provided for. However, it can be provided that the operating device 7 is actuated with the thumb in exceptional cases in special operating situations. This is typically the case when cleaning a roof.

The pressure control element 42 can be operated when gripping the handle area 14 with a single three-joint finger. During operation of the pressure control element 42 with the single three-joint finger, the valve control element 41 can be operated with another three-joint finger of the same hand.

The operating device 7 is preloaded in a non-actuated state. Both the valve control element 41 and the pressure control element 42 are preloaded independently of one another in a non-actuated state. A respective spring (not shown in the figures) can be used for this purpose.

In the exemplary embodiments, the operating device 7 is designed such that the pressure control element 41 can only be actuated when the valve control element 42 is actuated. However, it can also be provided that the pressure control element 41 can be actuated when the valve control element 42 is non-actuated.

The pressure washer 1 is designed such that on actuation of the valve control element 42, the main line valve 8 is transferred from the fully closed state 20 to the fully open state 40.

The pressure control element 41 can be adjusted within an adjustment area 31 shown in FIG. 5. The pressure control element 41 can assume different adjustment positions within the adjustment area 31. It can be provided that the pressure control element 41 can be adjusted solely in increments. In the exemplary embodiments, the pressure control element 41 can be adjusted continuously into adjustment positions within the adjustment area 31.

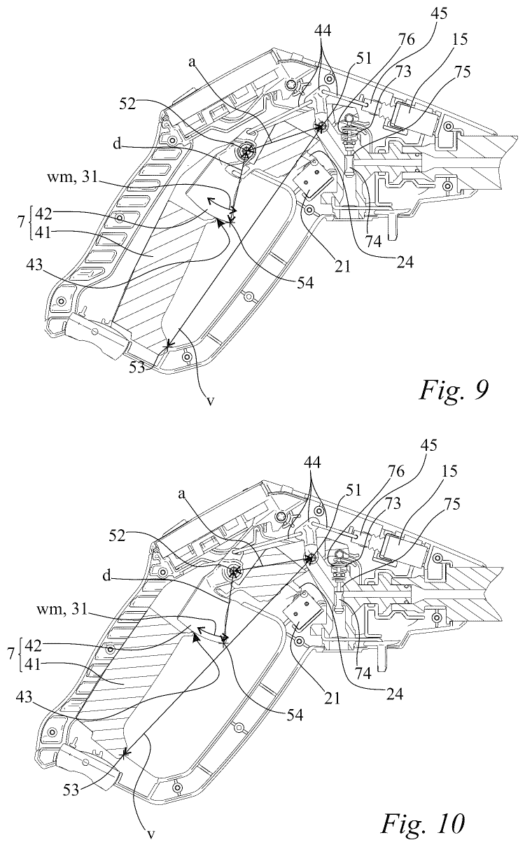

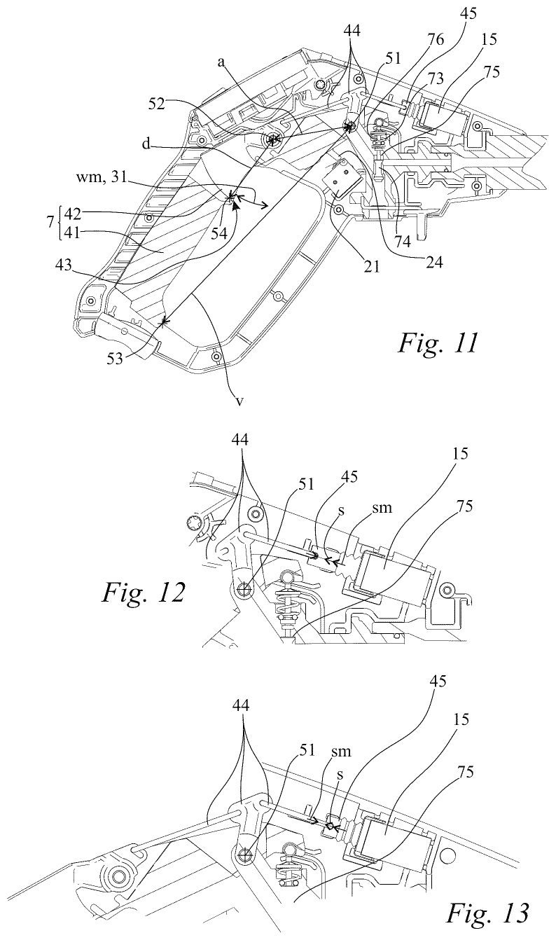

The pressure washer 1 comprises a detector 15. The detector 15 is shown schematically in FIGS. 5 to 8. The detector 15 is shown in detail in the sectional illustrations of the technical drawings according to FIGS. 9 to 11. The detector 15 is designed to detect an adjustment position of the pressure control element 41 of the operating device 7. The detector 15 can any continuous adjustment position of the pressure control element 41 within the adjustment area 31. It can be provided that the detector 15 a hall sensor is. In the exemplary embodiment, the detector 15 is a potentiometer. The operating device 7, in particular the pressure control element 42, and the detector 15 are arranged on the spray unit 11 in such a way that detection of the adjustment position of the pressure control element 41 is possible. The pressure control element 41 interacts with the detector 15 at least indirectly. In the exemplary embodiments, a mechanical connecting element 44 is arranged between the detector 15 and the pressure control element 42, as shown in FIGS. 9 to 11. The mechanical connecting element 44 couples the pressure control element 42 and the detector 15 to each other. By the mechanical connecting element 44, the pressure control element 42 interacts with the detector 15.

The detector 15 has a position element 45. The position element 45 can be adjusted along a maximum detector path sm. The maximum detector path sm and the position element 45 are shown enlarged in FIGS. 12 and 13. On the basis of a detector path s covered by a position element 45 of the detector 15 along the maximum detector path sm, the detector 15 determines the value of the pressure in the main line 5 that is specified by the pressure control element 42. In the exemplary embodiments, the position element 45 is a slider of the detector 15, which is designed as a potentiometer. However, it can also be provided that the position element is a magnet of the detector, which is designed as a hall sensor. FIG. 12 shows the position element 45 with non-actuated pressure control element 42. FIG. 13 shows the position element 45 with pressure control element 45 actuated at maximum. Owing to the actuation of the pressure control element 45, the position element 45 is adjusted by the detector path s along the maximum detector path sm. In this case, the position element 45 is moved in relation to a measuring unit of the detector 15, in the exemplary embodiment of a coil. The change in position of the position element 45 is detected by the measuring unit of the detector 15. The mechanical connecting element 44 mechanically connects the position element 45 and the pressure control element 42 to each other.

As shown in particular in FIGS. 5 to 7, the pressure control element 42 can be adjusted along a travel path in an adjustment area 31 from a rest position 37 into adjustment positions with increasing distance from the rest position 37. The pressure control element 42 assumes the maximum distance from the rest position 37 in an end position 38. In the end position 38, the pressure control element has covered the maximum travel path wm. The pressure washer 1 is designed such that, as the distance of the pressure control element 42 from the rest position 37 increases, the pressure of the liquid in the section of the main line 5 between the high-pressure pump 3 and the spray opening 6, in particular in the pressure chamber 10, rises or at least does not fall. In the exemplary embodiments, the pressure washer 1 is designed such that, as the distance of the pressure control element 42 from the rest position 37 increases, the bypass valve 13 reduces the open cross-sectional area of the bypass line 12 and/or at least does not enlarge it. A smaller volume of the liquid conveyed by the high-pressure pump 3 can flow back via the bypass line 12 from the pressure chamber 10 into the suction chamber 9. In the end position 38, the pressure in the section of the main line 5 between the high-pressure pump 3 and the spray opening 6, in particular in the pressure chamber 10, is at maximum when the main line valve 8 is in the fully open state 40.

It can be provided that the pressure along a region of the travel path remains constant. In particular, the pressure washer 1 can be designed such that the open cross-sectional area of the bypass line 12 remains the same along a section of the travel path, i.e. in multiple adjacent adjustment positions. In this way, multiple different pressure increments can be made available. Such a pressure increment can be selected by adjusting the pressure control element 42 into adjustment positions within a section of the travel path with an open cross-sectional area of the bypass line that stays the same. Multiple pressure increments can be provided.

The distance from the rest position 37 refers to the distance of a reference point on the pressure control element 42. In the exemplary embodiments, the pressure control element 42 is a pivot lever that is pivotable about a pressure control element pivot axis 52. In the exemplary embodiment, the reference point is the point of the pressure control element 42 with the greatest distance from the pressure control element pivot axis 52. This point is referred to as pressure point 54 and is shown in FIGS. 9 to 11. The pressure point 54 is arranged relative to the pressure control element pivot axis 52 on the side of the pressure control element 42 that is actuated by an operator. The corresponding distance of the pressure point 54 from the pressure control element pivot axis 52 is referred to as maximum pressure distance d. The rest position 37 is defined in the exemplary embodiments by the position of the reference point with pressure control element 42 non-actuated.

On actuation of the pressure control element 42, designed as pivot lever, in the rest position 37 of the pressure control element 42, the pressure control element 42 - and thus also the reference point - is pivoted along the travel path within the adjustment area 31. In this case, the travel path is a segment of a circle. The distance of the pressure control element 42 from the rest position 37 corresponds to distance of the reference point from the rest position 37 measured along the travel path designed as a segment of a circle. For reasons of better illustration, the travel path in FIGS. 9 to 11 is arranged radially slightly offset from the pressure point 54. In fact, the circular arc section line extends from the position of the pressure point 54 in FIG. 9. The pressure point 54 moves on a circular path with regard to the pivoting motion about the pressure control element pivot axis 52. It can also be provided to measure the distance in the form of an angular distance of the reference point from the rest position relative to a pivoting motion about the pressure control element pivot axis 52.

The pressure control element 42 can be adjusted along the maximum travel path wm (FIGS. 5 to 7 and 9 and 11). The maximum travel path wm of the pressure control element 42 is at least 110%, in particular at least 150%, in particular at least 200% of the maximum detector paths sm of the position element 45. The movement of the pressure control element 42 along its travel path is translated into a movement of the position element 45 along the travel path thereof. In this case, a pivoting motion of the pressure control element 42 is converted into a linear movement of the position element 45. For this purpose, the mechanical connecting element 45 comprises multiple joints.

The pressure washer 1 is designed such that the bypass valve 13 sets the size of the open cross-sectional area of the bypass line 12 depending on the adjustment position of the pressure control element 42. To this end, the detector 15 detects the adjustment position of the pressure control element 42 and generates a signal, on the basis of which the bypass valve 13 is adjusted.

In the exemplary embodiments, the operating device 7 protrudes, in particular the pressure control element 42 and the valve control element 41 protrude, out of the handle area 14. The handle area 14 borders in particular a handle opening 29 shown in FIG. 8. The handle opening 29 fully penetrates the spray unit 11, in particular towards the pressure control element pivot axis 52, in particular towards the valve control element pivot axis 51. When gripping and/or holding the spray unit 11, the operator uses their hand, in particular one or multiple of their, in particular three-joint, fingers, to reach through the handle opening 29. The handle opening 29 is bordered on the side opposite the handle area 14 by a hand guard bracket 32. The handle opening 29 has a fully wraparound edge. In the exemplary embodiments, the operating device 7 protrudes, in particular the pressure control element 42 and the valve control element 41 protrude, into the handle opening 29. This is the case in particular in the non-actuated state of the operating device 7.

In the exemplary embodiments, the valve control element 41 is a pivot lever that is pivotable about a valve control element pivot axis 51 shown in FIGS. 9 to 11. In particular, the pressure control element 42 is a pivot lever that is pivotable about a pressure control element pivot axis 52 shown in FIGS. 9 to 11.

The valve control element 41 has a valve point 53. The valve point 53 is the point of the valve control element 41 which, in relation to the position of the valve control element pivot axis 51, is arranged on the side of the valve control element 41 that faces the handle area 14 and has the maximum valve distance v from the valve control element pivot axis 51. The valve point 53 is in particular the point of the valve control element 41 which has the maximum valve distance v from the valve control element pivot axis 51. In particular, the valve point 53 is the point of the valve control element 41 which, in relation to the position of the valve control element pivot axis 51, is arranged on that side of the valve control element 41 that faces the handle area 14, which has the maximum valve distance v from the valve control element pivot axis 51 and simultaneously can still be actuated with a finger in the non-actuated state of the valve control element 41. In other words, the valve point 53 is not covered by other components, in particular not by the housing which borders the handle opening 29, meaning that it can be reached with a finger.

The pressure control element 42 has the pressure point 54 shown in FIGS. 9 to 11. The pressure point 54 is the point of the pressure control element 42 which, in relation to the position of the pressure control element pivot axis 52, is arranged on the side of the pressure control element 42 that faces the handle area 14 and which has the maximum pressure distance d from the pressure control element pivot axis 52. The pressure point 54 is in particular the point of the pressure control element 42 which has the maximum pressure distance d from the pressure control element pivot axis 52.

The maximum valve distance v is greater than the maximum pressure distance d. As a result, the valve control element 41 can be actuated by a user with a larger lever arm than the pressure control element 42. In the exemplary embodiments, the maximum valve distance v is at least 150%, in particular at least 200%, of the maximum pressure distance d.

As can be seen in FIGS. 2 to 4 and in particular in FIGS. 9 to 11, the valve control element 41 has a recess 43. The pressure control element 42 is received at least partially in the recess 43. In particular, the pressure control element 42 protrudes out of the recess 43 of the valve control element 41 out of the valve control element 41. In particular, the pressure control element 42 protrudes out of the recess 43 of the valve control element 41 into the handle opening 29. The recess 43 has an edge. This edge runs around closed. The edge runs in particular closed around the pressure control element 42. The edge borders an opening area of the recess. The pressure control element 42 dips through the opening area into the valve control element 41. When the pressure control element 42 is actuated at maximum, i.e. when the pressure control element 42 is pivoted the maximum amount towards the valve control element 41, and in particular when the valve control element itself maximal is actuated, the pressure control element 42 disappears almost fully into the valve control element 41. In particular, the pressure control element 42 is integrated in the valve control element 41. When the pressure control element 42 is pressed, one and the same finger can rest with a subsection of the finger on the pressure control element 42 and can simultaneously rest with another subsection of the finger on the valve control element 41. In this case, the pressure control element 42 is sunk into the recess 43 of the valve control element 41.

In the exemplary embodiments, the pressure control element 42 is pivotably mounted on the valve control element 41. The pressure control element pivot axis 52 runs through the valve control element 41. In particular, the pressure control element pivot axis 52 is arranged at a distance a from the valve control element pivot axis 51. During a pivoting motion of the valve control element 41 about the valve control element pivot axis 51, the pressure control element pivot axis 52 is pivoted together with the valve control element 41. The pressure control element pivot axis 52 is arranged, in relation to the valve control element pivot axis 51, on that side of the valve control element 41 that faces the handle area 14. When the operating device 7 is converted from the non-actuated state into the fully actuated state (if both valve control element 41 and pressure control element 42 are actuated at maximum), the pressure point 54 of the pressure control element follows a track that results from the superposition of two pivoting movements. On the one hand, the pressure control element pivot axis 52 is pivoted about the valve control element pivot axis 51; on the other hand, the pressure point 54 is pivoted about the pressure control element pivot axis 52. Therefore, the pressure point 54 is pivoted about the valve control element pivot axis 51 as well as about the pressure control element pivot axis 52.

The pressure washer 1 is designed such that a user can hold the handheld spray unit 11 by gripping the handle area 14 with one hand and can simultaneously actuate the control element 7 with solely three-joint fingers of the same hand. This is shown in FIG. 8. It can also be provided that the pressure washer 1 is designed such that a user can hold the handheld spray unit 11 by gripping the handle area with one hand and can simultaneously actuate the control element with solely one single three-joint finger of the same hand, in particular with the index finger.

As shown in FIG. 8, the handle area 14 is gripped with a single hand of a user. The hand has a thumb 61. The thumb 61 is a two-joint finger. The hand has four three-joint fingers. The three-joint fingers are an index finger 62, a middle finger 63, a ring finger 64 and a little finger 65.

The handle area 14 has a thumb side 33 and a control element side 34. The operating device 7 is arranged, and in particular the valve control element 41 and the pressure control element 42 are arranged, on the control element side 34. The thumb side 33 of the handle area 14 is provide for the thumb 41 to rest on. The control element side 34 is provide for the three-joint fingers 62, 63, 64, 65 to rest on. The thumb side 33 and the control element side 34 lie opposite each other. The handle area 14 extends along a handle longitudinal axis 48. The handle longitudinal axis 48 runs, in a side view of the handle area 14, between the thumb side 46 and the control element side 47. The handle area 14 is substantially rod-shaped. In particular, the handle longitudinal axis 48 runs in the longitudinal direction of the handle area 14. The handle longitudinal axis 48 runs in particular in a straight line. The handle longitudinal axis 48 does not intersect the handle area 14 that is provided for the fingers to rest on. The handle longitudinal axis 48 runs approximately centrally through the handle area 14. In the fully actuated state of the valve control element 41, the handle longitudinal axis 48 runs approximately, in particular exactly, parallel to a part of the grip surface of the valve control element 41.

While liquid is being sprayed, the spray unit 11 can be held with a single hand. In this case, the handle area 14 can be gripped with all fingers 61, 62, 63, 64, 65, in particular also with the thumb 61. To adjust the pressure in the section of the main line 5 between the high-pressure pump 3 and the spray opening 6, the thumb 61 does not need to be used.

Middle finger 63, ring finger 64 and little finger 65 rest on the valve control element 41. The valve control element 41 can be actuated by middle finger 63, ring finger 64 and little finger 65.

The extent of the pressure control element 42 in the direction of the handle longitudinal axis 48 is smaller than the extent of the valve control element 41 in the direction of the handle longitudinal axis 48. The extent of the pressure control element 42 in the direction of the handle longitudinal axis 48 is at most 50%, in particular at most 30%, the extent of the valve control element 41 in the direction of the handle longitudinal axis 48.

The handle opening 29 has an opening length l measured in the direction of the handle longitudinal axis 48. The opening length l corresponds to in particular the greatest distance, measured in the direction of the handle longitudinal axis 48, of the peripheral sections of the handle opening 29. The valve control element 41 extends at least over the entire opening length l. The valve control element 41 extends at most over 150%, in particular 130%, of the opening length l. The pressure control element 42 extends at most over 50%, in particular at most over 30% of the opening length l. The pressure control element 42 extends at least over 10% of the opening length l. As a result, the pressure control element 42 can be actuated with the index finger 62 and at the same time the valve control element 41 can be actuated with the middle finger 63, the ring finger 64 and/or the little finger 65 of the same hand. The pressure point 54 (FIG. 9) of the pressure control element 42 is arranged nearer to the valve control element pivot axis 51 than the valve point 53 of the valve control element 41. In particular, the pressure control element 42 extends from an upper edge of the handle opening 29, which is arranged closer to the valve control element pivot axis 51 than an opposite lower edge of the handle opening 29.

The index finger 62 rests on the pressure control element 42. The pressure control element 42 can be operated by the index finger 62. It is possible to operate the pressure control element 42 solely by the index finger 62. The pressure washer 1 is designed such that the pressure in the section of the main line 5 between the high-pressure pump 3 and the spray opening 6 can be set solely by a single three-joint finger, in the exemplary embodiment by the index finger 62. At the same time, the spray unit 11 can be held and controlled with the same hand. Liquid can be sprayed comfortably and safely during actuation of the pressure control element 42. The thumb 61 can be used to securely hold the spray unit 11. The thumb 61 does not need to be used to actuate a button or a lever.

The pressure washer 1, in particular the spray unit 11, is designed such that actuation of the operating device 7 by a user is possible during use of the pressure washer 1 both for switching the main line valve 8 between the fully open state 40 and the closed state 20 and for adjusting the pressure in the pressure chamber 10, in particular for adjusting the bypass valve 13, solely by using three-joint fingers 62, 63, 64, 65 on the same hand.

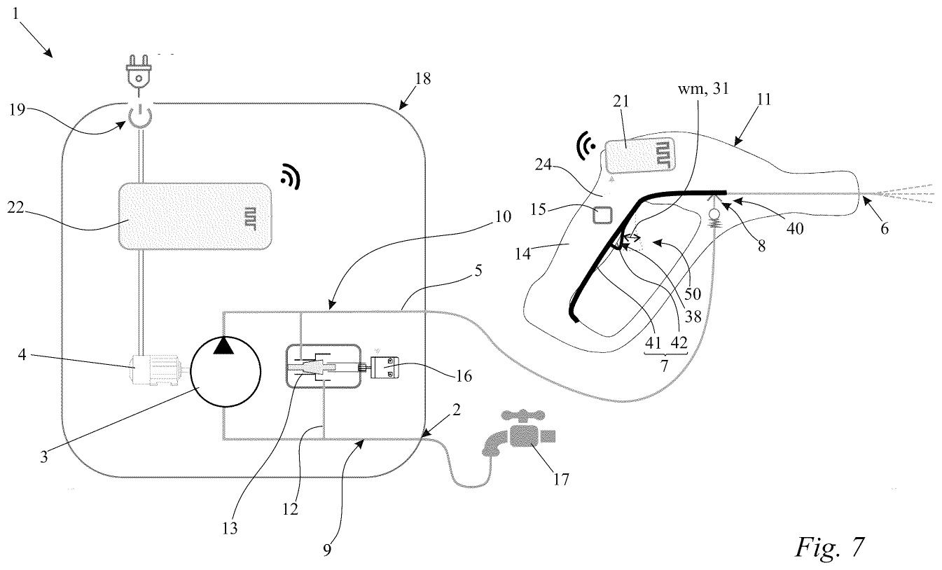

The use of the operating device 7 is depicted chronologically in FIGS. 5 to 7, beginning with the closed state 20 of the main line valve 8 in the non-actuated state 30 of the operating device 7, in particular in the non-actuated state of the pressure control element 42 (FIG. 5), and ending with the fully open state 40 of the main line valve 8 and a fully closed bypass valve 13 in the fully actuated state 50 (FIG. 7) of the operating device 7, in which both the valve control element 41 and the pressure control element 42 are actuated fully, in particular at maximum.

In FIG. 5, the operating device 7 is in the non-actuated state 30. Neither the valve control element 41 nor the pressure control element 42 are actuated. The main line valve 8 is closed. No liquid is sprayed from the spray opening 6. The bypass valve 13 is fully open. The pressure in the pressure chamber 10 is thereby minimised for the closed state 20 of the main line valve 8.

Proceeding from the non-actuated state 30 of the operating device 7 shown in FIG. 5, the valve control element 41 of the operating device 7 is first actuated. As a result, the main line valve 8 is transferred from the closed state 20 to the open state 40.

This half-actuated state 60 of the operating device 7, in which only the valve control element 41 and not the pressure control element 42 is actuated, is shown in FIG. 6. Liquid is sprayed from the spray opening 6. The pressure control element 42 is non-actuated. The bypass valve 13 is fully open. The pressure in the section of the main line 5 between the high-pressure pump 3 and the spray opening 6, or in the pressure chamber 10, is minimal for the fully open state 40 of the main line valve 8.

When transferring from the half-actuated state 60 of the operating device 7 shown in FIG. 6 to the fully actuated state 50 of the operating device 7 shown in FIG. 7, the valve control element 41 continues to be actuated. The main line valve 8 continues to be in the fully open state 40. The pressure control element 42 is lightly actuated, in particular in an adjustment position between the non-actuated and the fully actuated state of the pressure control element 42. The pressure control element 42 assumes an adjustment position between the rest position 37 (FIG. 6) and an end position 38 (FIG. 7) of the pressure control element 42. The bypass valve 13 is neither fully open nor fully closed; rather it is half open. The pressure in the section of the main line 5 between the high-pressure pump 3 and the spray opening 6, or in the pressure chamber 10, is greater than in FIG. 6, but smaller than in FIG. 7.

In FIG. 7, the pressure control element 42 is adjusted into the end position 38. The bypass valve 13 is fully closed. Due to the bypass line 12, no more liquid can flow from the pressure chamber 10 back into the suction chamber 9. The pressure in the pressure chamber 10 is maximum for the open state 40 of the main line valve 8. The valve control element 41 continues to be fully actuated. The main line valve 8 continues to be in the fully open state 40. The operating device 7 is in the fully actuated state 50. Liquid is sprayed from the spray opening 6 at maximum pressure.

Proceeding from the state shown in FIG. 7, the states shown in FIGS. 7 to 5 are run through in the reverse order up to the state shown in FIG. 5, in order to end the spraying of liquid from the spray opening 6. In this case, the pressure control element 42 is first released so that the pressure in the pressure chamber 10 falls again, because the bypass valve 13 is continuously open. Finally, the actuation of the valve control element 41 is ended so that the main line valve 8 is closed and the spraying process is ended. The bypass valve 13 is then fully open and ensures pressure equalisation between the pressure chamber 10 and the suction chamber 9.

The pressure washer 1 has a control unit 22 shown in FIGS. 5 to 7. The control unit 22 is arranged in the pump unit 18. It can also be provided that the control unit 22 is arranged in the spray unit 11. The signal generated by the detector 15 is transmitted to the control unit 22 directly or indirectly, in particular in the form of a wireless, in particular electromagnetic, signal. The signal received by the control unit 22 is used to change the pressure in the section of the main line 5 between the high-pressure pump 3 and the spray opening 6, in particular to set said pressure, in particular to adjust the open cross-sectional area of the bypass line 12 by the bypass valve 13. To this end, the control unit 22 sends a further signal to the bypass valve 13.

The bypass valve 13 can be adjusted by a servomotor 16. The servomotor 16 is arranged in the pump unit 18. By the servomotor 16, the bypass valve 13 can be adjusted in such a way that the open cross-sectional area of the bypass line 12 can be set. Because of the signal received by the control unit 22 from the detector 15, the further signal is generated in the control unit 22 and transmitted to the servomotor 16. In the exemplary embodiment, the further signal is transmitted electrically by a cable. However, it can also be provided that the further signal is transmitted wirelessly, in particular electromagnetically. Because of the further signal, the servomotor 16 adjusts the bypass valve 13. By the servomotor 16, the bypass valve 13 can be adjusted in such a way that continuous adjustment of the size of the open cross-sectional area of the bypass line 12 is possible. The size of the open cross-sectional area can be adjusted continuously by the operating device 7, in particular by the pressure control element 42, at least in sections.

The main line valve 8 is opened by the valve control element 41 mechanically in the exemplary embodiment. In the exemplary embodiments, the main line valve 8 comprises a valve spring 73 shown in FIGS. 9 to 11, a valve member 74 and a valve seat 75. The valve spring 73 preloads the valve member 74 against the valve seat 75. In the non-actuated state of the valve control element 41, the valve spring 73 presses the valve member 74 against the valve seat 75. The main line valve 8 is in the closed state 20. During actuation of the valve control element 41, a force acts on the main line valve 8, which transfers the main line valve 8 from the closed state 20 to the fully open state 40. The valve control element 41 acts, in particular with its side averted from the valve control element pivot axis 51 of the handle area 14, in particular its longitudinal end, on a valve tappet 76 of the main line valve 8, so that the valve tappet 76 moves the valve member 74 away from the valve seat 75 against the force of the valve spring 73, and in this way transfers the main line valve 8 to the fully open state 40. Liquid can then flow through the main line 5 to the spray opening 6.

With actuation of the valve control element 41, the control unit 22 receives a signal in the exemplary embodiments. The control unit 22 only allows a change in the pressure as a result of actuation of the pressure control element 42 if a signal that is generated by the valve control element 41 being actuated is also received in the control unit 22 at the same time. However, it can also be provided that the pressure can be adjusted independently of the actuation of the valve control element 41.

The motor 4 of the pressure washer 1, in particular the pump unit 18, has two operating states. The two operating states include an on state and an off state. In the off state, the motor 4 is off. No electrical power is provided to operate the motor 4. In the on state of the motor 4, the motor 4 is on. In the on state 30, the motor 4 is driven by electrical power.

The pressure washer 1, in particular the spray unit 11, is designed in all exemplary embodiments such that the motor 4 can be set by the operating device 7, in particular by the valve control element 41, to one of the two operating states. By the operating device 7, in particular by the valve control element 41, can the motor 4 can be adjusted from the off state to the on state. By the operating device 7, in particular by the valve control element 41, the motor 4 can be adjusted from the on state to the off state.

The pressure washer 1, in particular the spray unit 11, is designed in all exemplary embodiments such that adjustment of the operating state of the motor 4 is only possible if the main line valve 8 is in the fully open state 40. The motor 4 can only be transferred from the off state to the on state if the main line valve 8 is in the fully open state 40. The motor 4 can only be transferred from the on state to the off state if the valve 8 is in the fully open state 40.

The pressure washer 1, in particular the spray unit 11, is designed in all exemplary embodiments such that adjusting the valve state of the main line valve 8 is only possible when the motor 4 is in the off state. The main line valve 8 can only be transferred from the closed state 20 to the fully open state 40 if the motor 4 is in the off state. The main line valve 8 can only be transferred from the fully open state 40 to the closed state 20 if the motor 4 is in the off state.

The pressure washer 1, in particular the spray unit 11, is designed in all exemplary embodiments such that an electrical signal can be generated directly by the operating device 7, in particular directly by the valve control element 41. The generation of the electrical signal occurs in the exemplary embodiments by allowing or preventing a flow of current. In this case, a switch 21 shown in FIGS. 9 to 11 is actuated, which closes or opens a circuit, thereby allowing or preventing a flow of current. In the exemplary embodiments, the switch 21 is a microswitch. However, it can also be provided that a potentiometer is used instead of the switch 21. Then, the resistance of the potentiometer is changed by actuation of the operating device 7, in particular of the valve control element 41, such that current can flow or no current can flow through the circuit in which the potentiometer is arranged.

In the exemplary embodiments, the operating device 7, in particular the valve control element 41, acts mechanically on the switch 21 and in this way directly generates an electrical signal. Stopping a flow of current is also referred to as generating an electrical signal or as an electricals signal.

As a result of the electrical signal generated directly by the operating device 7, in particular by the valve control element 41, the motor 4 can be set in all exemplary embodiments to at least one of the two operating states of the motor 4. The electrical signal can be an electrical on signal. The electrical signal can be an electrical off signal. If, in the exemplary embodiments, the operating device 7, in particular the valve control element 41, generates an electrical on signal, this allows current to flow in a circuit. If, the exemplary embodiments, the operating device 7, in particular the valve control element 41, generates an electrical off signal, this stops current from flowing in a circuit.

Owing to the generation of the electrical on signal, the motor 4 is transferred from its off state to its on state transferred. Owing to the generation of the electrical off signal, the motor 4 is transferred from its on state to its off state.

The pressure washer 1 is designed in all exemplary embodiments in such a way that the motor 4 is set to one of the two operating states of the motor 4 as a result of the electrical signal generated directly by the operating device 7, in particular directly by the valve control element 41, irrespective of the pressure conditions in the main line 5.

If the motor 4 is in its on state and the main line valve 8 is in its fully open state 40, in all of the exemplary embodiments liquid is conveyed from the port 2 through the main line 5 to the spray opening 6. This state is achieved by actuating the operating device 7, in particular by actuating the valve control element 41. Before the pressure washer 1 is started up, the motor 4 is in the off state. The operating device 7, in particular the valve control element 41, is non-actuated. The main line valve 8 is in the closed state 20. This state of the pressure washer 1 is shown in FIG. 5 or in FIG. 9. When the main line valve 8 is closed and the motor 4 of the high-pressure pump 3 is switched off, no liquid is conveyed through the main line 5.

In the exemplary embodiments according to FIGS. 5 to 7, or 9 to 11, the main line valve 8 is transferred by the valve control element 41 from its closed state 20 shown in FIG. 5, or FIG. 9, into its fully open state 40 shown in FIGS. 6 and 7, or 8 and 9, respectively. Only after opening the main line valve 8, is the electrical signal triggered by the valve control element 41 to convert the motor 4 from its off state to its on state. The pressure washer 1 is designed such that the motor 4 can only be set to the on state after the closed state 20 of the main line valve 8 has ended. In the exemplary embodiment according to FIGS. 9 to 11, the valve control element 41 has a switching arm 24 for this purpose. The switching arm 24 switches the switch 21 in the manner and order described. On actuation of the valve control element 41, the switching arm 24 is pivoted about the valve control element pivot axis 51 as part of the valve control element 41. During this pivoting motion, the closed state 20 of the main line valve 8 is first ended, i.e. the main line valve 8 is opened, and then the switch 21 is switched by the switching arm 24. In the exemplary embodiments, the switch 21 is pressed, in particular by the switching arm 24, when the valve control element 41 is not actuated. When the switch is pressed, the electrical power supply of the motor 4 is interrupted. After the pivoting of the valve control element 41, i.e. when the valve control element 41 is actuated, the switching arm 24 is moved away from the switch 21 such that the switch 21 is no longer pressed. Only when the switch 21 is not being pressed is the motor 4 supplied with electrical power. The high-pressure pump 3 only conveys liquid if the main line valve 8 is open, in particular is in the fully open state 40. On release of the valve control element 41, the switch 21 is first pressed, in particular by the switching arm 24, and this interrupts the supply of electrical power to the motor 4. Only then does the valve control element 41 actuate the main line valve 8 and transfers it to the closed state 20 in the process.

The switching arm 24 is a projection of the valve control element 41. The switching arm 24 is arranged on that side of the valve control element 41 which, with respect to the valve control element pivot axis 51, faces the handle area 14. The main line valve 8 is connected to the side of the valve control element 41, in particular to the longitudinal end of the valve control element 41, which, with respect to the valve control element axis 41, is averted from the handle area 14. The valve control element axis 41 is functionally arranged between the switching arm 24 and the longitudinal end the valve control element 41 for switching the main line valve 8. The valve control element 41 is mounted in the spray unit 11, in particular in a housing of the spray unit 11, so that it can pivot about the valve control element pivot axis 51.

What is claimed is:

1. A pressure washer, comprising:
a port (2) for a liquid source (17);
a high-pressure pump (3);
a main line (5) configured to convey liquid from the port (2) to a spray opening (6) in the main line (5) by the high-pressure pump (3);
a main line valve (8) arranged in the main line (5); and
an operating device (7) including
a valve control element (41) and
a pressure control element (42),
the pressure control element (42) being operable independently of the valve control element (41),
wherein the main line valve (8) is switchable by the valve control element (41) between a closed state (20), in which a flow of the liquid through the main line (5) is stopped, and an open state (40), in which the liquid flows through the main line (5), and
wherein a pressure of the liquid in the main line (5) in a section between the high-pressure pump (3) and the spray opening (6) can be set by the pressure control element (42).

2. The pressure washer according to claim 1,
wherein the pressure washer (1) has a handheld spray unit (11),
wherein the spray opening (6) is arranged on the handheld spray unit (11), and
wherein the operating device (7) is arranged on the handheld spray unit (11).

3. The pressure washer according to claim 2,
wherein the handheld spray unit (11) has a handle area (14),
wherein a user can guide the handheld spray unit (11) when gripping the handle area (14), and
wherein the valve control element (41) and the pressure control element (42) can be operated together with a single hand of the user when gripping the handle area (14).

4. The pressure washer according to claim 2,
wherein the handheld spray unit (11) has a handle area (14),
wherein a user can guide the handheld spray unit (11) when gripping the handle area (14), and
wherein the valve control element (41) and the pressure control element (42) can be operated together with a single finger of the user when gripping the handle area (14).

5. The pressure washer according to claim 3,
wherein the pressure control element (42) can be operated with a single three-joint finger when gripping the handle area (14), and during operation of the pressure control element (42) with the single three-joint finger, the valve control element (41) can be operated with another three-joint finger of the same hand.

6. The pressure washer according to claim 1,
wherein the valve control element (42) is a pivot lever that is pivotable about a valve control element pivot axis (51),
wherein the pressure control element (42) is a pivot lever that is pivotable about a pressure control element pivot axis (52),
wherein the valve control element (41) has a valve point (53) arranged at a maximum valve distance (v) from the valve control element pivot axis (51) wherein the pressure control element (42) has a pressure point (54) arranged at a maximum pressure distance (d) from the pressure control element pivot axis (52), and
wherein the maximum valve distance (v) is greater than the maximum pressure distance (d).

7. The pressure washer according to claim 1,
wherein the valve control element (41) has a recess (43), and
wherein the pressure control element (42) is received at least partially in the recess (43).

8. The pressure washer according to claim 1,
wherein the valve control element (41) has a recess (43), and
wherein the pressure control element (42) protrudes through the recess (43).

9. The pressure washer according to claim 1,
wherein the pressure control element (42) is pivotably mounted on the valve control element (41).

10. The pressure washer according to claim 6,
wherein the pressure control element pivot axis (52) is arranged at a distance (a) from the valve control element pivot axis (51).

11. The pressure washer according to claim 1,
wherein the pressure washer (1) has a motor (4) for driving the high-pressure pump (3),
wherein the motor (4) has an off state and an on state,
wherein the motor (4) can be adjusted between the off state and the on state by the valve control element (41).

12. The pressure washer according to claim 1,
wherein the pressure washer (1) comprises a detector (15), and
wherein the detector (15) is designed to detect an adjustment position of the pressure control element (42).

13. The pressure washer according to claim 12,
wherein a mechanical connecting element (44) is arranged between the detector (15) and the pressure control element (42),
wherein, based on a detector path(s) covered by a position element (45) of the detector (15), the detector (15) determines a value of the pressure in the main line (5) specified by the pressure control element (42),
wherein the position element (45) can be adjusted along a maximum detector path (sm),
wherein the pressure control element (42) can be adjusted along a maximum travel path (wm), and wherein the maximum travel path (wm) corresponds to at least 110% of the maximum detector path (sm).

14. The pressure washer according to claim 1,
wherein the main line (5) has a suction chamber (9) between the port (2) and the high-pressure pump (3), wherein the main line (5) has a pressure chamber (10) between the high-pressure pump (3) and the spray opening (6),
wherein the pressure chamber (10) is fluidically connected to the suction chamber (9) via a bypass line (12),
wherein a bypass valve (13) is arranged in the bypass line (12),
wherein an open cross-sectional area of the bypass line (12) can be set by the bypass valve (13) in order to regulate the pressure in the pressure chamber (10), and wherein the bypass valve (13) can be adjusted by the pressure control element (42) in order to set the open cross-sectional area of the bypass line (12).

15. The pressure washer according to claim 1,
wherein the pressure of the liquid in the main line (5) in the section between the high-pressure pump (3) and the spray opening (6) can be specified without increments by the pressure control element (42).

16. The pressure washer according to claim 11,
wherein the pressure washer (1) is constructed such that it is only possible to adjust the operating state of the motor (4) between the off state and the on state if the main line valve (8) is in the open state (40).

17. A handheld spray unit (11) for a pressure washer (1) including
a port (2) for a liquid source (17),
a high-pressure pump (3),
a main line (5) configured to convey liquid from the port (2) to a spray opening (6) in the main line (5) by the high-pressure pump (3), and
a main line valve (8) arranged in the main line (5), the main line valve (8) being switchable between a closed state (20), in which liquid flow through the main line (5) is stopped, and an open state (40), in which liquid flows through the main line (5),
the handheld spray unit (11) comprising:
an operating device (7) having
a valve control element (41) for switching the main line valve (8) between the open state (40) and the closed state (20), and
a pressure control element (42) for setting a pressure of the liquid in the main line (5) in a section between the high-pressure pump (3) and the spray opening (6), and
wherein the pressure control element (42) is operable independently of the valve control element (41).
